(19) United States
(12) Patent Application Publication
(10) Pub. No.: US 2026/0348913 A1
(43) Pub. Date: Nov. 5, 2026

(54) Interface between ion trap and detection chamber of a charged aerosol detector

(71) Applicant: Dionex Softron GmbH, Germering (DE)

(72) Inventors: Benjamin Eggart, Munich (DE); Alexandra Scherz, Munich (DE)

(21) Appl. No.: 19/198,180

(22) Filed: May 5, 2025

(51) Int. Cl. G01N 27/62; G21K 1/00

(52) U.S. Cl. CPC G01N 27/62; G21K 1/00

(57) ABSTRACT

The present invention relates to an interface for guiding charged particles from an ion trap into a detection chamber, the interface comprising an electrically conductive tube configured to establish a connection for the charged particles between the ion trap and the detection chamber; and an insulating member surrounding at least a portion of the tube and configured to establish an electrically insulated connection between the tube and the detection chamber. Furthermore, the present invention relates o an assembly comprising an ion trap, a detection chamber, and a respective interface as well as a respective method.

The present invention generally relates to charged aerosol detectors and particularly to an interface for transporting the aerosol from an ion trap to the detection chamber.

A charged aerosol detector (CAD) may generally be configured to generate a dried, secondary aerosol of an analyte which is subsequently mixed with positively charged ions to generate a charged secondary aerosol through charge diffusion. In order to reliably measure charged aerosol particles excess ions are typically filtered in an ion trap. Subsequently the charged secondary aerosol is guided into a detection chamber, wherein an ion current of the secondary aerosol may be measured in a Farraday cup.

Generally, there may be a desire to suppress (and ideally prevent) any loss of charges on the aerosol particles during guiding of the charged secondary aerosol from an area where it is charged (e.g. a mixing chamber) through the ion trap and to the detection chamber, while at the same time removing excess ions.

Loss of charges on the aerosol particles may mainly occur owing to transport losses due to diffusion of charges and owing to locally generated charges that cannot flow away (charge agglomeration through triboelectricity). The latter charge agglomeration on surfaces in the gas flow may disadvantageously provide an electric field, which may, similar to the ion trap, deflect the charged aerosol to the walls rendering it unavailable for measurement. Thus, these sources may advantageously be minimized.

Additionally, while using a Farraday cup may advantageously be reliable and robust, and also allow for an absolute measurement of the ion current, which is temporally constant, it is very sensitive and should be well electrically insulated from the surroundings of the device. This may typically be achieved through a thick layer of insulating material, and thus contradict the desire to keep the flow path short to minimize diffusion losses.

Further, a Faraday cup may comprise a relatively long time constant (typically around 0.1 s) owing to its intrinsic capacitance in conjunction with very high discharge resistance in the amperemeter (10 GOhm). These may typically result in a poorer detection sensitivity (typically 2000 ions/s) and lower bandwidth compared to what would theoretically be possible, which results in a long response time.

Thus, due to the sensitivity and inertia of the ion current measurement (and also due to the negative effect on charged particles), great care may be taken to ensure that local agglomeration of charges is suppressed and ideally prevented, i.e. that all surfaces may have good electrical conductivity. Charge agglomeration that spontaneously flows off via the Farraday cup or is spontaneously transported away by the gas flow would otherwise disadvantageously lead to signals that are not related to the measurement. However, this may also necessitate the Farraday cup to be very well electrically insulated from the surroundings of the device, including an inlet of the Farraday cup.

In current designs an insulation of the Faraday cup with respect to the ion trap is realized by using a feed for guiding the aerosol into the Faraday cup that is made of insulating material. The insulating property may be achieved by selecting a suitable material. Typically, a plastic may be used for this purpose. However, particularly plastics may disadvantageously lead to a generation of charges through the triboelectric effect, when the gas flow carrying the charged aerosol flows over their surface. A resulting agglomeration of charges may have multiple disadvantages as discussed above.

In this regard, PCTFE (polychlorotrifluoroethylene) may show the best insulating properties while having suitable triboelectric properties (little to no friction charge induction on the surface). However, it may require a certain thickness to also provide the desired insulation properties. This may to some extend limit the possibilities to keep the transport path of the aerosol short in order to reduce the negative effect of diffusion of charges over time. In contrast, tests with PEEK (polyether ether ketone) or PTFE (polytetrafluoroethylene) have shown that these materials may generally be unsuitable because they generate a high degree of charge on the surfaces due to the gas flowing past.

Guiding the charged aerosol through a plastic feed may additionally comprise the following disadvantages: the feed must be sealed to an outlet of the ion trap and a good fit may be required to the outlet of the ion trap so that there are no edges in the flow path that may otherwise obstruct the gas flow.

In light of the above, it is an object to overcome or at least alleviate the shortcomings and disadvantages of the prior art. More particularly, it is an object of the present invention to provide an improved feed from the ion trap into the detection chamber of a CAD.

These objects are met by the present invention.

In a first aspect, the present invention relates to an interface for guiding charged particles from an ion trap into a detection chamber, the interface comprising an electrically conductive tube configured to establish a connection for the charged particles between the ion trap and the detection chamber, and an insulating member surrounding at least a portion of the tube and configured to establish an electrically insulated connection between the tube and the detection chamber.

In other words, the present invention relates to an interface between an ion trap and a detection chamber, e.g. within a CAD, wherein the charged particles are merely guided through an electrically conductive tube and do not come into direct contact with the insulating member that surrounds the tube. This may advantageously allow to improve the performance of such an interface compared to the state of the art, since charge agglomeration on the insulating member, e.g. owing to triboelectricity, may be supressed, or even prevented. Further, since the tube itself is not involved in insulating the ion trap from the detection chamber, it may be shorter than in current designs, which allows to reduce diffusion losses.

The tube may be configured to partially project into the detection chamber.

The tube may be made of metal. This may be preferred as a high electric conductivity may generally be desired for the tube.

The tube may generally be configured to guide a gas and/or aerosol from an outlet of the ion trap to the detection chamber.

The tube may provide a flow path from a tube inlet to a tube outlet. The flow path may be defined by a continuous, seamless inner wall of the tube.

A downstream end of tube may extend beyond a downstream end of the insulating member. This may again aid with preventing any interaction of charged particles being guided through the tube with the insulating member and thus reduce the risk of agglomerated charges, e.g., due to triboelectricity.

The tube may be configured to be fluidly and electrically connected to the ion trap. Thus, the tube may be configured to receive a flow of gas and/or a charged aerosol from the ion trap while being at the same electrical potential as the ion trap, which may preferably be grounded.

The tube may comprise a tube length L_{T} in the range of 0.1 mm to 300 mm, preferably in the range of 10 mm to 50 mm. Additionally or alternatively, the tube comprises an inner tube diameter D_{T} in the range of 1 mm to 50 mm, preferably in the range of 2 mm to 10 mm.

The insulating member may be made of an electrically insulating material. In particular, the insulating member may be made of plastic. For example, he insulating member may be made of PTFE, PCTFE or PEEK, preferably PEEK or PTFE. Alternatively, the insulating member may be made of a ceramic.

The insulating member may be configured to fix the tube coaxially to the detection chamber (or vice versa). That is, the insulating member may not only electrically insulate the detection chamber from the tube but also ensure a relative position thereto by fixing the tube and detection chamber to each other such that the relative position is maintained, whereby the tube runs coaxially with respect to the detection chamber.

An upstream portion of the insulating member may abut the tube. This may allow for the insulating member to fix the tube relative to the detection chamber to which the insulating member may also be connected.

The insulating member may preferably be sealingly connected to the tube. The interface may comprise an O-ring for sealingly connecting the insulating member to the tube. Alternatively, the insulating member may be sealingly glued or press-fit to the tube. In particular, an upstream portion of the insulating member may be sealingly connected to the tube.

The interface may comprise an insulating gap between a downstream portion of the insulating member and the tube. In other words, a downstream portion of the insulating member may surround the tube such that an insulating gap is provided between the downstream portion of the insulating member and the tube.

The insulating gap may be filled with air. Thus, the insulating gap may be an air gap. Alternatively, the insulating gap may be filled with a solid, insulating material. For example, the insulating gap may be filled with a glue, foam, or resin. Generally, the insulating gap may be configured to insulate the downstream portion of the insulating member from the tube. A distance between the downstream portion of the insulating member and the tube may be in the range of 100 μm to 10 mm. It will be understood that this distance denotes the width of the insulating gap between the downstream portion of the insulating member and the tube.

In some embodiments, the insulating member and the tube may be made of a composite material. That is, they may be made of a composite material that comprises a metallic surface on one side and an insulating surface on the other side. Such a composite material may for example be provided through two-component injection moulding.

In another aspect, the present invention relates to an assembly comprising an ion trap, a detection chamber, and an interface according to the present invention (as for example described above). The tube may be fluidly connected to the ion trap. In particular, the tube inlet may be fluidly connected to an ion trap outlet. Further, the tube inlet may be fluidly connected to a chamber outlet of the ion trap.

The tube may be electrically connected to the ion trap.

The tube may be permanently connected to the ion trap.

The ion trap may comprise a housing and wherein the tube may be integrally formed with the housing of the ion trap. That is, the housing of the ion trap and the tube may be formed of a single part. This may advantageously ensure a good electrical connection therebetween and avoid any undesired unevenness (e.g., edges or gaps) due to a non-perfect fit between separate parts.

The tube may extend into the detection chamber. Preferably, a downstream end of the tube may extend further into the detection chamber than a downstream end of the insulating member. In other words, the tube may extend further into an inner volume of the detection chamber than the insulating member.

The tube outlet may be located within the detection chamber.

The tube may be mounted coaxially to the detection chamber by means of the insulating member.

The insulating gap may be fluidly connected to the detection chamber. In particular, the insulating gap may be filled with the same air as the detection chamber.

The detection chamber may be a Faraday cup.

The insulating member may be sealingly connected to the detection chamber. Additionally or alternatively, the insulating member may be comprised by the detection chamber. The insulating member may be permanently fixed to a portion of the detection chamber. For example, the insulating member and at least a portion of the detection chamber may be made of a composite material.

In another aspect, the present invention relates to a charged aerosol detector (CAD) comprising a nebulizer, a spray chamber comprising an impactor, a drying tube, a mixing chamber, a Corona charger, an ion trap, a detection chamber, and an interface according to the present invention as for example described above. The CAD may comprise an assembly comprising the ion trap, the detection chamber, and the interface, wherein the assembly is an assembly according to the present invention as for example described above.

In another aspect, the present invention relates to a method of guiding charged particles from an ion trap to a detection chamber within a charged aerosol detector (CAD), comprising guiding charged particles from an ion trap into a detection chamber, wherein the charged particles are not guided along a surface of insulating material. This may advantageously allow to suppress and ideally prevent triboelectric effects, which may otherwise lead to undesired charge agglomeration on the insulating material.

The step of guiding charged particles from the ion trap into the detection chamber may comprise guiding the particles through a single, continuous metal tube.

The step of guiding charged particles from the ion trap into the detection chamber comprises guiding the particles through an interface according to the present invention as for example described above.

The ion trap and the detection chamber may be comprised by an assembly according to the present invention as for example described above.

The method may further comprise applying an electric field within the ion trap configured to remove highly mobile charged particles.

The method may further comprise detecting charges of the charged particles provided to the detection chamber.

Below, reference will be made to interface embodiments. These embodiments are abbreviated by the letter “I” followed by a number. Whenever reference is herein made to “interface embodiments”, these embodiments are meant.
I1. Interface for Guiding Charged Particles From an Ion Trap Into a Detection Chamber, the interface comprising
an electrically conductive tube configured to establish a connection for the charged particles between the ion trap and the detection chamber; and
an insulating member surrounding at least a portion of the tube and configured to establish an electrically insulated connection between the tube and the detection chamber.
I2. The interface according to the preceding interface embodiment, wherein the tube is configured to partially project into the detection chamber.
I3. The interface according to any of the preceding interface embodiments, wherein the tube is made of metal.
I4. The interface according to any of the preceding interface embodiments, wherein the tube is configured to guide a gas and/or aerosol from an outlet of the ion trap to the detection chamber.
I5. The interface according to any of the preceding interface embodiments, wherein the tube provides a flow path from a tube inlet to a tube outlet.
I6. The interface according to the preceding interface embodiment, wherein the flow path is defined by a continuous, seamless inner wall of the tube.
I7. The interface according to any of the preceding interface embodiments, wherein a downstream end of tube extends beyond a downstream end of the insulating member.
I8. The interface according to any of the preceding interface embodiments, wherein the tube is configured to be fluidly and electrically connected to the ion trap.
I9. The interface according to any of the preceding interface embodiments, wherein the tube comprises a tube length L_{T} in the range of 0.1 mm to 300 mm, preferably in the range of 10 mm to 50 mm.
I10. The interface according to any of the preceding interface embodiments, wherein the tube comprises an inner tube diameter D_{T} in the range of 1 mm to 50 mm, preferably in the range of 2 mm to 10 mm.
I11. The interface according to any of the preceding interface embodiments, wherein the insulating member is made of an electrically insulating material.
I12. The interface according to any of the preceding interface embodiments, wherein the insulating member is made of plastic.
I13. The interface according to any of the preceding interface embodiments, wherein the insulating member is made of PTFE, PCTFE or PEEK, preferably PEEK or PTFE.
I14. The interface according to any of the interface embodiments I1 to I12, wherein the insulating member is made of a ceramic.
I15. The interface according to any of the preceding interface embodiments, wherein the insulating member is configured to fix the tube coaxially to the detection chamber (or vice versa).
I16. The interface according to any of the preceding interface embodiments, wherein an upstream portion of the insulating member abuts the tube.
I17. The interface according to any of the preceding interface embodiments, wherein the insulating member is sealingly connected to the tube.
I18. The interface according to the preceding interface embodiment, wherein the interface comprises an O-ring for sealingly connecting the insulating member to the tube.
I19. The interface according to the penultimate interface embodiment, wherein the insulating member is sealingly glued or press-fit to the tube.
I20. The interface according to any of the 3 preceding interface embodiments, wherein an upstream portion of the insulating member is sealingly connected to the tube.
I21. The interface according to any of the preceding interface embodiments, wherein the interface comprises an insulating gap between a downstream portion of the insulating member and the tube.

In other words, a downstream portion of the insulating member may surround the tube such that an insulating gap is provided between the downstream portion of the insulating member and the tube.
I22. The interface according to the preceding interface embodiment, wherein the insulating gap is filled with air.
I23. The interface according to the penultimate interface embodiment, wherein the insulating gap is filled with a solid, insulating material.
I24. The interface according to the preceding interface embodiment, wherein the insulating gap is filled with a glue, foam, or resin.
I25. The interface according to any of the 4 preceding interface embodiments, wherein the insulating gap is configured to insulate the downstream portion of the insulating member from the tube.
I26. The interface according to any of the 5 preceding interface embodiments, wherein a distance between the downstream portion of the insulating member and the tube is in the range of 100μm to 10 mm.
I27. The interface according to any of the preceding interface embodiments, wherein the insulating member and the tube are made of a composite material.

That is, they may be made of a composite material that comprises a metallic surface on one side and an insulating surface on the other side.
I28. The interface according to any of the preceding interface embodiments excluding I27, wherein the insulating member is mounted to the tube by means of press-fitting or glueing.

Below, reference will be made to assembly embodiments. These embodiments are abbreviated by the letter “A” followed by a number. Whenever reference is herein made to “assembly embodiments”, these embodiments are meant.
A1. An assembly comprising an ion trap, a detection chamber and an interface according to any of the preceding interface embodiments.
A2. The assembly according to the preceding assembly embodiment, wherein the tube is fluidly connected to the ion trap.
A3. The assembly according to any of the preceding assembly embodiment, wherein the interface comprises the features of I5 and wherein the tube inlet is fluidly connected to an ion trap outlet.
A4. The assembly according to any of the preceding assembly embodiments, wherein the interface comprises the features of I5 and wherein the tube inlet is fluidly connected to a chamber outlet of the ion trap.
A5. The assembly according to any of the preceding assembly embodiments, wherein the tube is electrically connected to the ion trap.
A6. The assembly according to any of the preceding assembly embodiments, wherein the tube is permanently connected to the ion trap.
A7. The assembly according to any of the preceding assembly embodiments, wherein the ion trap comprises a housing and wherein the tube is integrally formed with the housing of the ion trap.
A8. The assembly according to any of the preceding assembly embodiments, wherein the tube extends into the detection chamber.
A9. The assembly according to any of the preceding assembly embodiments, wherein a downstream end of the tube extends further into the detection chamber than a downstream end of the insulating member.

In other words, the tube may extend further into an inner volume of the detection chamber than the insulating member.
A10. The assembly according to any of the preceding assembly embodiments, wherein the interface comprises the features of I5 and wherein the tube outlet is located within the detection chamber.
A11. The assembly according to any of the preceding assembly embodiments, wherein the tube is mounted coaxially to the detection chamber by means of the insulating member.
A12. The assemble according to any of the preceding assembly embodiments, wherein the interface comprises the features of I21 and wherein the insulating gap is fluidly connected to the detection chamber.
A13. The assembly according to any of the preceding assembly embodiments, wherein the interface comprises the features of I21 and wherein the insulating gap is filled with the same air as the detection chamber.
A14. The assembly according to any of the preceding assembly embodiments, wherein the detection chamber is a Faraday cup.
A15. The assembly according to any of the preceding assembly embodiments, wherein the insulating member is comprised by the detection chamber.
A16. The assembly according to any of the preceding assembly embodiments, wherein the insulating member is sealingly connected to the detection chamber.
A17. The assembly according to any of the preceding assembly embodiments, wherein the insulating member and at least a portion of the detection chamber are made of a composite material.
A18. The assembly according to any of the preceding assembly embodiments, wherein the insulating member is permanently fixed to a portion of the detection chamber.

Below, reference will be made to CAD embodiments. These embodiments are abbreviated by the letter “C” followed by a number. Whenever reference is herein made to “CAD embodiments”, these embodiments are meant.
C1. Charged aerosol detector (CAD) comprising a nebulizer, a spray chamber comprising an impactor, a drying tube, a mixing chamber, a Corona charger, an ion trap, a detection chamber, and an interface according to any of the preceding interface embodiments.
C2. Charged aerosol detector according to the preceding CAD embodiment, wherein the CAD comprises an assembly comprising the ion trap, the detection chamber, and the interface, wherein the assembly is an assembly according to any of the preceding assembly embodiments.

Below, reference will be made to method embodiments. These embodiments are abbreviated by the letter “M” followed by a number. Whenever reference is herein made to “method embodiments”, these embodiments are meant.
M1. Method of guiding charged particles from an ion trap to a detection chamber within a charged aerosol detector (CAD), comprising
   guiding charged particles from an ion trap into a detection chamber,
   wherein the charged particles are not guided along a surface of insulating material.
M2. Method according to the preceding method embodiment, wherein the step of guiding charged particles from the ion trap into the detection chamber comprises guiding the particles through a single, continuous metal tube.
M3. Method according to any of the preceding method embodiment, wherein the step of guiding charged particles from the ion trap into the detection chamber comprises guiding the particles through an interface according to any of the preceding interface embodiments.
M4. Method according to any of the preceding method embodiments, wherein the ion trap and the detection chamber are comprised by an assembly according to any of the preceding assembly embodiments.
M5. The method according to any of the preceding method embodiments, wherein the method further comprises applying an electric field within the ion trap configured to remove highly mobile charged particles.
M6. The method according to any of the preceding method embodiments, wherein the method further comprises detecting charges of the charged particles provided to the detection chamber.

Embodiments of the present invention will now be described with reference to the accompanying drawings. These embodiments should only exemplify, but not limit, the present invention.

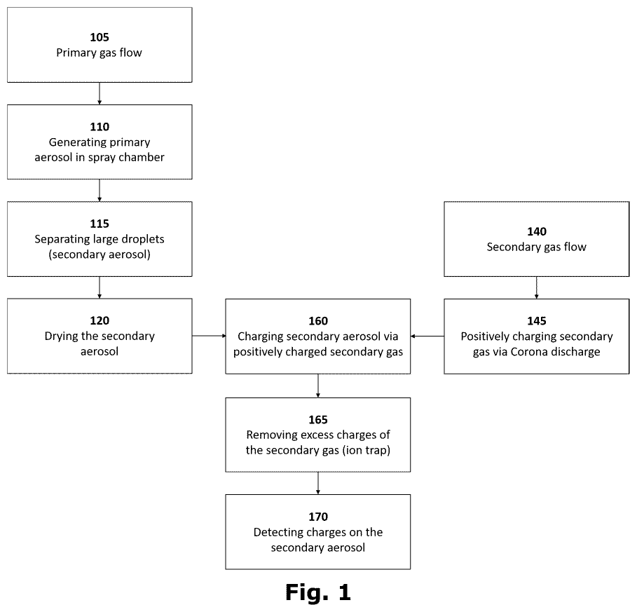

FIG. 1 depicts a flow diagram of charged aerosol detection;

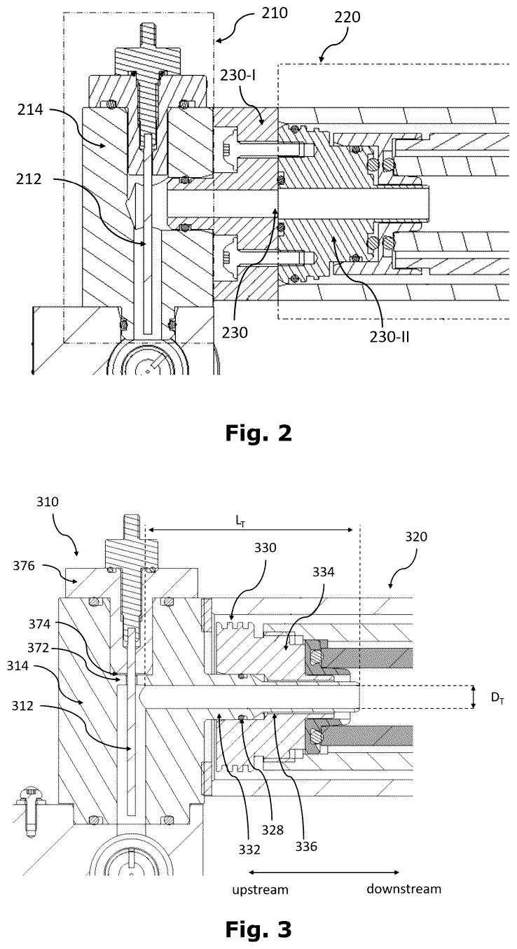

FIG. 2 depicts a prior art ion trap, feed, and detection chamber;

FIG. 3 depicts an embodiment of an assembly according to the present invention comprising an ion trap, an interface, and a detection chamber;

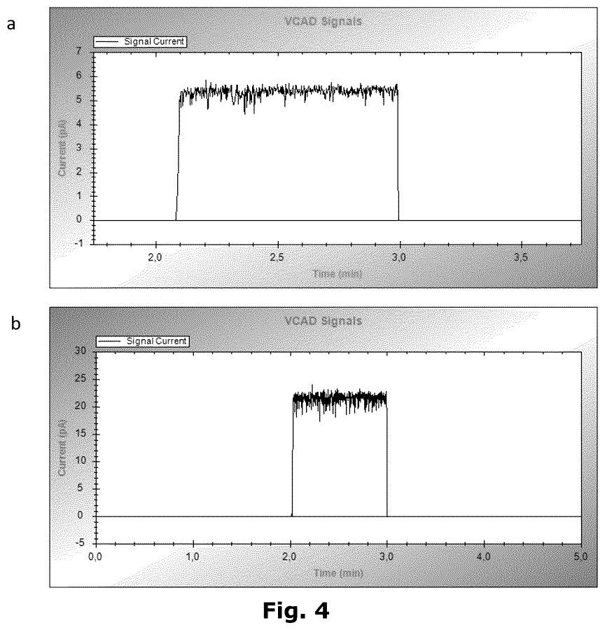

FIG. 4 illustrates a transmission of highly mobile charges of an assembly according to the present invention in comparison to a prior art assembly; and

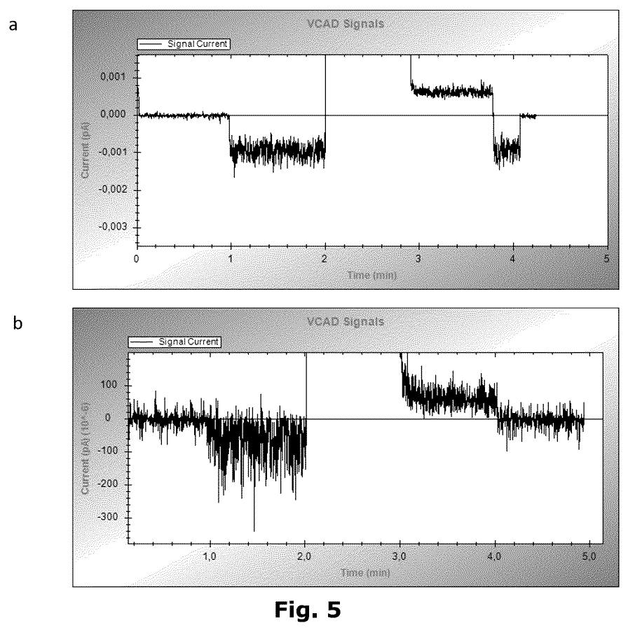

FIG. 5 illustrates a further comparative measurement between a known assembly and an embodiment according to the present invention.

It is noted that not all the drawings carry all the reference signs. Instead, in some of the drawings, some of the reference signs have been omitted for the sake of brevity and simplicity of the illustration. Embodiments of the present invention will now be described with reference to the accompanying drawings.

Very generally a charged aerosol detector (CAD) serves to measure the charge of an aerosol of an analyte, which may comprise particles with a diameter in the range of 10 nm to 100 μm. Prior to detecting the aerosol a few steps may typically be performed in a CAD.

While the principle of a CAD is generally known in the art, an exemplary very general workflow of a CAD is briefly discussed with reference to FIG. 1. Firstly, by aid of a primary gas flow 105 a primary aerosol of the analyte may be generated in a spray chamber through nebulization 110, e.g. pneumatic nebulization. Secondly, while the primary aerosol is guided through the spray chamber large droplets may be removed using an impactor to generate a secondary aerosol 115. Subsequently, the secondary aerosol may be dried 120, e.g. by guiding it through a heated evaporation tube.

A secondary gas flow 140 may be provided and the secondary gas may be positively charged via a Corona discharge 145. The positively charged secondary gas, e.g. nitrogen ions, and the dried secondary aerosol may then be mixed in a mixing chamber to charge the secondary aerosol by means of the positively charged secondary gas 160. Subsequently excess charges of the secondary gas may be removed 165, typically using an ion trap. Finally, charges on the secondary aerosol may be detected 170, e.g. within a Faraday cup in a detection chamber.

With reference to FIG. 2 a sectional view of an assembly comprising an ion trap 210 and a downstream detection chamber 220 as currently known in the art is briefly discussed. Again, once the secondary aerosol has been charged 145, the charge applied by diffusion may be measured in the detection chamber 220. For this reason, excess positive charges may advantageously be filtered in the ion trap 210. Said filtering may be carried out by means of inertia.

A rod 212 may be placed concentrically in a flow path through the ion trap 210 and a positive electric potential may be applied to the rod 212. This may result in an electric field being generated between the rod 212 and a housing 214 of the ion trap, which defines the flow path and may typically be electrically grounded. Thus, a positive electric potential on the rod may generate an electric field in the flow path. Generally, a ratio of electric field strength and velocity in the flow path may determine which charge/mass ratio is filtered. The positively charged ions (e.g. nitrogen ions) have a high mobility due to their low mass compared to the positively charged secondary aerosol particles. They may therefore be pressed against an outer wall of the flow path provided by the housing 214 and their charge may flow off via the ground of the housing 214. The low mobility of the secondary aerosol particles may allow it to flow through, ideally unhindered.

Once the charged secondary aerosol has passed through the ion trap 210, it may be fed into the detection chamber 220 via a respective feed 230. In the detection chamber 220 charges of the secondary aerosol may be measured, e.g. using a Faraday cup. The measured ion currents may typically be in the range from 30 fA to 1 nA.

As can be seen in FIG. 2, current designs may rely on an insulating feed 230, which guides the aerosol into the Faraday cup and at the same time provides the required insulation of the Faraday cup with respect to the ion trap. A first portion of the feed 230-I may be conductive and reach into the ion trap 210, to which it may be electrically connected such that it may be at the same electrical potential. A second portion 230-II may be insulating to provide the electrical insulation between the ion trap 210 and the detection chamber 220. That is, in current designs an interface 230 (or feed) between the ion trap 210 and the detection chamber 220 may comprise two parts 230-I, 230-II, each providing a portion of the flow path. This may for example be disadvantageous due to the discontinuous inner surface for the gas and/or aerosol that is guided from a chamber of the ion trap to the detection chamber.

Further, as already discussed such a known solution may have additional disadvantages: Firstly, it generally requires a certain length to ensure good electrical insulation and may thus limit the extent to which the overall flow path between ion trap and Faraday cup may be kept short (to reduce diffusion losses). Secondly, the insulating material may be prone to agglomeration of charges due to triboelectricity since part of the flow path may be provided by a surface of insulating material. However, local agglomeration of charges may preferably be prevented in the ion trap as well as in the feed as it may be disadvantageous for several reasons: On the one hand, it may lead to erroneous measurement signals due to spontaneous dissipation of agglomerated charges via the Faraday cup and/or spontaneous transport of agglomerated charges via the gas flow. On the other hand, within the feed it may also act on the charged aerosol similar to the ion trap, in that agglomerated charges provide an electric field which may deflect charged aerosols towards interior walls of the feed, thus rendering them unavailable for measurement.

And finally, the feed is further sealed to an outlet of the ion trap and a good fit may be required to the outlet of the ion trap so that there are no edges in the flow path that may otherwise obstruct the gas flow.

To alleviate these shortcomings and disadvantages, the present invention generally provides an interface for guiding the aerosol from the ion trap to the detection chamber (e.g., Faraday cup), which comprises a metallic tube and an insulating member surrounding at least a portion of the metallic tube. The insulating member may be configured to allow for an electrically insulated connection between the tube and the detection chamber, e.g. the Faraday cup.

With reference to FIG. 3 an exemplary embodiment of an interface 330 according to the preceding invention is discussed. The interface 330 may comprise an electrically conductive tube 332, preferably a metal tube 332, which may be configured to guide a gas and/or aerosol flow from an outlet of the ion trap 310 to a detection chamber 320. The tube 332 may be electrically insulated from the detection chamber 330 by means of an insulating member 334, which surrounds at least a portion of the tube 332. The insulating member 334, may establish a mechanical connection between the tube 332 and the detection chamber 330, wherein said connection is electrically insulated.

The tube 332 may protrude into the detection chamber 320. In particular a downstream end of the tube 332 may protrude further into the detection chamber 320 than a downstream end of the insulating member 334. In other words, the tube 332 may extend further into an inner volume of the detection chamber 320 than the insulating member 334.

Additionally, the interface 330 may comprise an insulating gap 336 between a downstream portion of the insulating member 334 and the tube 332. The insulating gap 336 may for example be an air gap, i.e. it may be filled with air. Generally, the insulating gap 336 may improve insulating properties between the interface and the detection chamber 320. It will be understood that the insulating gap 336 may comprise different geometries. It may for example be larger than depicted in the exemplary embodiment and/or comprise a different shape. In particular, the geometry of the insulating gap 336 may depend on the geometry insulating member 334. The distance between the downstream portion of the insulating member 334 and the tube 332, which may constitute the insulating gap 336, may be in the range of 100 μm to 10 mm.

In some embodiments the insulating gap may be filled with an insulating material. For example, the insulating gap 336 may be filled with a glue (e.g., two-component glue), foam, or resin. Any liquid material that can be hardened and that is non-conductive after being hardened may be viable.

The insulating member 334 may be made of an electrically insulating material, e.g. a plastic. For example, the insulating member 334 may be made of PTFE or PEEK. Alternatively, the insulating member may be made of a ceramic. The insulating member 334 may be comprised by the detection chamber 320.

During operation there may be a slight overpressure within the detection chamber, e.g. up to 300 mbar above ambient pressure. Thus, the interface may comprise a seal 328 (e.g., an O-ring) between the tube 332 and the insulating member 334, to provide for a sufficiently tight connection therebetween. Alternatively, the insulating member may be glued or press-fit to the tube.

The tube 332 may generally be connected to the ion trap 310. Preferably, the tube may not only be connected mechanically but also electrically to the ion trap 310. In some embodiments, the tube 332 may be permanently connected to the housing 314 of the ion trap. In particular, the tube 332 may be integrally formed with the housing 314 of the ion trap. This may advantageously allow for a good electrical connection and prevent any obstacles in the flow path due to imperfect alignment of the ion trap 310 and the interface 330.

Preferably, an upstream end of the tube 332 may extend up to a chamber of the ion trap, such that the tube 332 may receive the aerosol at an outlet of the chamber of the ion trap 332 and guide it to the detection chamber 320.

The tube may comprise a tube length L_{T} in the range of 0.1 mm to 300 mm, preferably 10 mm to 50 mm. Additionally, the tube 332 may comprise an inner tube diameter D_{T} in the range of 1 mm to 50 mm, preferably 2 mm to 10 mm.

In some embodiments, a composite material may be used, particularly a composite material that may be insulating and metallic. In particular, it may allow to provide a material with a metallic surface on one side and an insulating surface on another side. This may for example allow for the insulating member and the tube to be made of a composite material and/or the insulating member and a part of the detection chamber, e.g., the equipotential metal of the Faraday cup. Such a composite material may for example be manufactured using two-component injection moulding.

Thus, the insulating member 334 may in some embodiments be integrated into the detection chamber 320, e.g., Faraday cup. That is, the insulating member may be permanently fixed to a portion of the detection chamber 320, e.g., via glueing soldering or two-component injection moulding.

In other words, the present invention may provide an interface comprising a continuous metal tube for feeding the aerosol from the ion trap to the detection chamber. Compared to plastics, metal may offer the best electrical properties for dissipating potentially generated surface charges. The metal tube may extend into the Faraday cup through a respective insulation. Thus, the insulating material may no longer directly interact with the gas/aerosol flow from the ion trap to the Faraday cup. Therefore, a choice of insulating material may be decoupled from its triboelectric properties. This may advantageously allow usage of a plastic with very good electrical insulation properties, such as PTFE or PEEK.

Furthermore, the continuous channel provided by the metal tube may advantageously not require any sealing within the channel, as required in the prior art, where the insulating feed requires a sealed connection to the ion trap. Similarly, it does not require precise fitting of connecting parts to avoid a disadvantageous influence on the gas flow with the aerosol. Instead, it may provide a flow path with a smooth, continuous surface. In addition to the improved flow properties, a shorter transport path may also be realised by design.

Furthermore, the insulating gap provides for an additional insulation of the metal tube from the detection chamber.

The Farraday cup may retain its metallic surface perfectly and may thus be able to dissipate the electrical charge of the aerosol to the amperemeter.

Thus overall, the aerosol may be fed from the ion trap continuously with a metal tube. Charges potentially generated by friction (triboelectricity) may be optimally dissipated owing to the excellent electrical properties of the metal. The electrical insulation of the detection chamber (e.g. Faraday cup) may be moulded around the tube. An insulating gap (e.g. air gap) may also ensure that charges at the surface cannot flow onto the insulating member of the Faraday cup, i.e. it may prevent flow of charges. Additionally, at a point where insulating member 334 and tube 332 meet, potential charges on the insulating member 334 can be dissipated via the conducting tube 332 owing to the good conductivity and connection to ground. Furthermore, since the downstream end of the tube 332 protrudes further into the detection chamber than the downstream end of the insulating member 334, potential charges on the insulating member may not influence charged aerosol particles being guided into the detection chamber. The downstream end of the tube may for example extend beyond the downstream end of the insulating member by 0.01 mm to 300 mm, preferably 0.1 mm to 45 mm.

With respect to FIGS. 4 to 5, exemplary measurements are discussed that showcase improvements achieved with the present invention in comparison to state-of-the-art designs. It is noted that in addition to the present invention also the design of the ion trap is improved by introducing a separation portion 372 and a trap insulating gap 374 to avoid charge agglomeration on the trap insulating member 376. Further details regarding this new ion trap design can be found in US patent application XXX, which is incorporated by reference in its entirety.

FIG. 4a shows a current measured owing to positively charged nitrogen ions in a Faraday cup wherein the Faraday cup is fluidly connected to the upstream ion trap via an assembly comprising a feed according to the state of the art (cf. FIG. 2). FIG. 4b shows the same measurement with an assembly comprising an interface according to the present invention and an improved ion trap design. The ion trap was switched off for both of these measurements to provide a high flow of positively charged nitrogen atoms.

As can be seen, the present invention allows to achieve a current level which is about four times higher than with a state-of-the-art feed/interface. This highlights the improved transmission of charged particles owing to the present invention and the improved ion-trap design.

Similarly, FIG. 5a depicts a measurement conducted with a state-of-the-art assembly, whereas FIG. 5b depicts a measurement conducted with an assembly comprising an interface according to the present invention and an improved ion-trap design.

With reference to FIG. 5a from minute 0 to 1 the thermal noise of the amperemeter is measured. Subsequently, from minute 1 to 2 aerosol particles that were not charged with positive nitrogen ions in the mixing chamber are measured. Here, the natural charge of aerosol particles originating from a water eluent of the HPLC can be seen. However, this would generally be expected to be nearly neutral, i.e. similar to the measurement between minute 0 and 1. From minute 2 to 3 positively charged nitrogen ions are introduced and the ion trap is switched off. Expectedly, the signal increases as the excess positive nitrogen ions are measured along with the aerosol particles from the water eluent. From minute 3 to 4 the ion trap is switched on, while the aerosol particles from the water eluent are charged by positive nitrogen ions in the mixing chamber. This represents the normal state in the detector.

With reference to FIG. 5b the same measurement is shown with an interface according to the present invention. It is noted that the y-axis indicating the current in pA is scaled by a factor 10⁻⁶ compared to FIG. 5a. As expected, the natural charge of the aerosol from water eluent in minute 1 to 2 is almost neutral and comparable to the state when no aerosol enters the detector (minute 0 to 1). In addition, the signal of the normal measurement state (minute 3 to 4) is also significantly reduced. This may be generally be attributed to less influence of charges agglomerated on insulating material, e.g. owing to triboelectricity. Overall, this comparative measurement shows that the aerosol particles to be analysed are not charged or influenced by the flow through the device, i.e. it indicates a reduction of triboelectricity, and that background noise is reduced because the charges enter the detection chamber more continuously.

Whenever a relative term, such as “about”, “substantially” or “approximately” is used in this specification, such a term should also be construed to also include the exact term. That is, e.g., “substantially straight” should be construed to also include “(exactly) straight”.

Whenever steps were recited in the above or also in the appended claims, it should be noted that the order in which the steps are recited in this text may be accidental. That is, unless otherwise specified or unless clear to the skilled person, the order in which steps are recited may be accidental. That is, when the present document states, e.g., that a method comprises steps (A) and (B), this does not necessarily mean that step (A) precedes step (B), but it is also possible that step (A) is performed (at least partly) simultaneously with step (B) or that step (B) precedes step (A). Furthermore, when a step (X) is said to precede another step (Z), this does not imply that there is no step between steps (X) and (Z). That is, step (X) preceding step (Z) encompasses the situation that step (X) is performed directly before step (Z), but also the situation that (X) is performed before one or more steps (Y1), . . . , followed by step (Z). Corresponding considerations apply when terms like “after” or “before” are used.

While in the above, a preferred embodiment has been described with reference to the accompanying drawings, the skilled person will understand that this embodiment was provided for illustrative purpose only and should by no means be construed to limit the scope of the present invention, which is defined by the claims.

1. Interface for guiding charged particles from an ion trap into a detection chamber, the interface comprising
an electrically conductive tube configured to establish a connection for the charged particles between the ion trap and the detection chamber; and
an insulating member surrounding at least a portion of the tube and configured to establish an electrically insulated connection between the tube and the detection chamber.

2. The interface according to claim 1,
wherein the tube provides a flow path from a tube inlet to a tube outlet; and
wherein the flow path is defined by a continuous, seamless inner wall of the tube.

3. The interface according to claim 1, wherein the insulating member is sealingly connected to the tube.

4. The interface according to claim 1, wherein a downstream end of tube extends beyond a downstream end of the insulating member.

5. The interface according to claim 1, wherein the tube is configured to be fluidly and electrically connected to the ion trap.

6. The interface according to claim 1, wherein the interface comprises an insulation gap between a downstream portion of the insulating member and the tube.

7. An assembly comprising an ion trap, a detection chamber and an interface, the interface comprising
an electrically conductive tube configured to establish a connection for the charged particles between the ion trap and the detection chamber; and
an insulating member surrounding at least a portion of the tube and configured to establish an electrically insulated connection between the tube and the detection chamber.

8. The assembly according to claim 7, wherein the tube is fluidly and electrically connected to the ion trap.

9. The assembly according to claim 7, wherein the ion trap comprises a housing and wherein the tube is integrally formed with the housing of the ion trap.

10. The assembly according to claim 7, wherein a downstream end of the tube extends further into the detection chamber than a downstream end of the insulating member.

11. The assembly according to claim 7, wherein the detection chamber is a Faraday cup.

12. The assembly according to claim 7, wherein the insulating member is sealingly connected to the detection chamber.

13. Method of guiding charged particles from an ion trap to a detection chamber within a charged aerosol detector (CAD), comprising
guiding charged particles from an ion trap into a detection chamber,
wherein the charged particles are not guided along a surface of insulating material.

14. Method according to claim 13, wherein the step of guiding charged particles from the ion trap into the detection chamber comprises guiding the particles through a single, continuous metal tube.

15. The method according to claim 13, wherein the method further comprises detecting charges of the charged particles provided to the detection chamber.

16. Method according to claim 13, wherein the step of guiding charged particles from the ion trap into the detection chamber comprises guiding the particles through an interface, the interface comprising
an electrically conductive tube configured to establish a connection for the charged particles between the ion trap and the detection chamber; and
an insulating member surrounding at least a portion of the tube and configured to establish an electrically insulated connection between the tube and the detection chamber
